(19) United States
(12) Patent Application Publication
(10) Pub. No.: US 2023/0388303 A1
(43) Pub. Date: Nov. 30, 2023

(54) NETWORK SYSTEM AND INFORMATION PROVIDING METHOD

(71) Applicant: Canon Kabushiki Kaisha, Tokyo (JP)

(72) Inventor: MOMOE UCHIDA, Kanagawa (JP)

(21) Appl. No.: 18/321,832

(22) Filed: May 23, 2023

(30) Foreign Application Priority Data
May 31, 2022 (JP) 2022-088880

(51) Int. Cl. H04L 9/40; H04N 1/00; H04N 1/44

(52) U.S. Cl. CPC H04L 63/0876; H04N 1/00344; H04N 1/4433; H04N 1/00244; H04L 63/1416; H04L 63/104

(57) ABSTRACT

A network system is provided. The system comprises an image processing apparatus; an information processing apparatus including a web browser; a service providing a website; and a device management system that gathers and manages security information received from the image processing apparatus. The information processing apparatus transmits a request for authorization information to the service providing system, and, in response to receiving authorization information, transmits a security information display request to the device management system. The device management system, when allowing the user logged into the service providing system, transmits security information display information to the information processing apparatus. The information processing apparatus receives the security information display information from the device management system and displays a screen including the security information display information via the web browser.

### BACKGROUND OF THE INVENTION

### Field of the Invention

The present invention relates to a network system and an information providing method.

### Description of the Related Art

The state of a device connected to the Internet can be managed remotely with recent technology. For example, the method described in Japanese Patent No. 6591832 includes remotely detecting the presence of not only malware infecting a storage area of a hard disk but also malware embedded in firmware of the hard disk. The information processing apparatus and lockout management system according Japanese Patent No. 6201468 improve security by appropriately managing the lockout state of a user for the information processing apparatus on a network.

In the known technology, the security information, such as the tampering and lockout state of a device, can be detected remotely. However, no mention is made of a method for remotely presenting the security information to an administrator managing the device.

### SUMMARY OF THE INVENTION

The present invention provides a network system and an information providing method for presenting gathered security information to a target person in a safe and integrated manner.

The present invention has the following configuration. First aspect of the present invention provides a network system comprising: an image processing apparatus; an information processing apparatus including a web browser; a service providing system that provides a website; and a device management system that gathers and manages security information received from the image processing apparatus, wherein the information processing apparatus, in response to receiving a display instruction for security information from a user logging into the service providing system via the web browser via a user operation, transmits a request for authorization information to the service providing system, the information processing apparatus, in response to receiving authorization information issued by the device management system from the service providing system via the web browser, transmits a security information display request including the authorization information and a specification of a device identifier to the device management system, the device management system, when allowing the user logged into the service providing system access to the security information on a basis of verification of the authorization information included in the security information display request, transmits security information display information associated with the device identifier to the information processing apparatus, and the information processing apparatus receives the security information display information from the device management system and displays a screen including the security information display information via the web browser.

According to the present invention, gathered security information can be presented to a subject in a safe and integrated manner.

Further features of the present invention will become apparent from the following description of exemplary embodiments with reference to the attached drawings.

### BRIEF DESCRIPTION OF THE DRAWINGS

FIG. 1 is a diagram illustrating a network configuration.

FIG. 2A is a diagram illustrating the hardware configuration of an image forming apparatus.

FIG. 2B is a diagram illustrating the hardware configuration of an information processing apparatus, a customer information management server, and a cloud server.

FIG. 3A is a diagram illustrating the software configuration of the cloud server.

FIG. 3B is a diagram illustrating the software configuration of the image forming apparatus.

FIG. 3C is a diagram illustrating the software configuration of the customer information management server.

FIG. 3D is a diagram illustrating the software configuration of the information processing apparatus.

FIGS. 4A to 4C are diagrams illustrating example of authorization information issued by the cloud server.

FIGS. 5A to 5F are diagrams illustrating examples of screens provided by the cloud server.

FIGS. 6A and 6B show a flowchart of the processing according to a first embodiment.

FIGS. 7A-1 and 7A-2 show a flowchart of the processing according to the first embodiment.

FIG. 7B is a flowchart of the processing according to the first embodiment.

FIG. 8 is a diagram illustrating an example of authorization information issued according to a second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Network Configuration

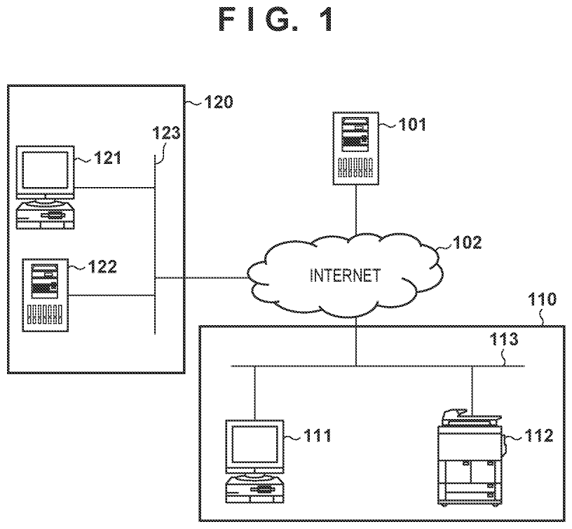

FIG. 1 is a diagram illustrating the network configuration of a remote management system (also referred to as a network system) using the present invention. A cloud server 101 is a server that gathers and records security information of an image forming apparatus and issues and verifies authorization information for a customer information management server 122. The cloud server 101 can communicate with various types of apparatuses via the Internet 102. Note that in the example in FIG. 1, one image forming apparatus 112, one information processing apparatus 111, and one information processing apparatus 121 are connected to the network, but a plurality of one or more may also be connected. Note that when focusing on the image processing function of an image forming apparatus, the apparatus may be referred to as an image processing apparatus. Also, the cloud server 101 may be constituted by one or more computers and may be referred to as a device management system as it manages devices such as an image forming apparatus.

A customer network environment 110 is a network environment for a customer that has purchased the image forming apparatus 112. In the customer network environment 110, the image forming apparatus 112 and the information processing apparatus 111 are connected via a Local Area Network (LAN) 113. The LAN 113 can be connected to the Internet 102. A customer administrator can use the information processing apparatus 111, connect to the customer information management server 122, and check the security information of the image forming apparatus 112. This check is performed by displaying the security information on the information processing apparatus 111 via the customer information management server 122.

A distributor network environment 120 is a network environment for a distribution company that manages the state and performs remote maintenance of the image forming apparatus. In the distributor network environment 120, the information processing apparatus 121 and the customer information management server 122 are connected via a LAN 123. The LAN 123 can be connected to the Internet 102.

Only one distributor network environment 120 is illustrated in the example in FIG. 1, but a plurality may exist for each region including Japan, Europe, and the like. Also, in this example, it is assumed that the customer information management server 122 manages each image forming apparatus 112 within the customer network environments 110. The customer information management server 122 may be constituted by one or more computers and is also referred to as a service providing system as it provides a service such as providing information to a customer.

### Hardware Configuration

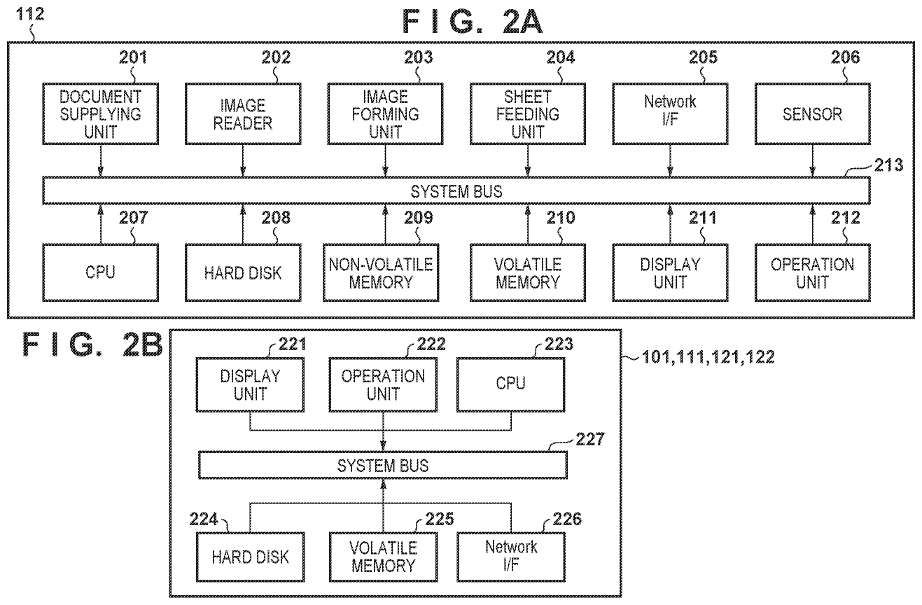

FIGS. 2A and 2B are diagrams illustrating the hardware configuration of an apparatus constituting a remote management system using the present invention. FIG. 2A illustrates the hardware configuration of the image forming apparatus 112, and FIG. 2B illustrates the hardware configuration of the information processing apparatuses 111 and 121, the customer information management server 122, and the cloud server 101. When the customer information management server 122 and the cloud server 101 are constituted by a plurality of computers, each computer may have the configuration illustrated in FIG. 2B.

The image forming apparatus 112 has the configuration illustrated in FIG. 2A. A document supplying unit 201 automatically supplies an image reader 202 with documents to read. The image reader 202 (for example, a scanner) reads the supplied documents. An image forming unit 203 converts the read document and received data to a print image and performs printing. A sheet feeding unit 204 feeds paper for printing. A network interface (UF) 205 is connected to the LAN 113 and the Internet 102 via a network and exchanges information with outside.

A sensor 206 detects the state of the components of the present apparatus. A CPU 207 executes programs and controls the processing executed in the present apparatus. A hard disk 208 stores programs and data relating to the processing of the present apparatus. A non-volatile memory 209 is a rewritable memory that can retain storage without a power supply and is Ferroelectric Random Access Memory (FRAM (registered trademark)), for example. A volatile memory 210 is a rewritable memory that can electrically store temporary data relating to the processing of the present apparatus. A display unit 211 displays the operation status of the present apparatus and information relating to the operations on an operation unit 212. The operation unit 212 receives the input of instructions for the present apparatus. The display unit 211 and the operation unit 212 constitute the user interface. A system bus 213 joins the components from the document supplying unit 201 to the operation unit 212 and exchanges data. However, the entire configuration may be not connected to one bus, and one or more blocks may form a subsystem which is connected to the system bus 213.

The information processing apparatuses 111 and 121, the customer information management server 122, and the cloud server 101 have the configuration illustrated in FIG. 2B. A display unit 221 displays windows, icons, messages, menus, and other user interface information. An operation unit 222 receives input from an end user using a keyboard and a mouse. A CPU 223 executes programs and controls the processing executed in the present apparatus. A hard disk 224 stores programs and data relating to the processing of the present apparatus. A volatile memory 225 is a rewritable memory that can electrically store temporary data relating to the processing of the present apparatus. A network OF 226 is connected to the LANs 113 and 123 and the Internet 102 via a network and exchanges information with outside. A system bus 227 joins the components from 221 to 226 and exchanges data.

### Software Configuration

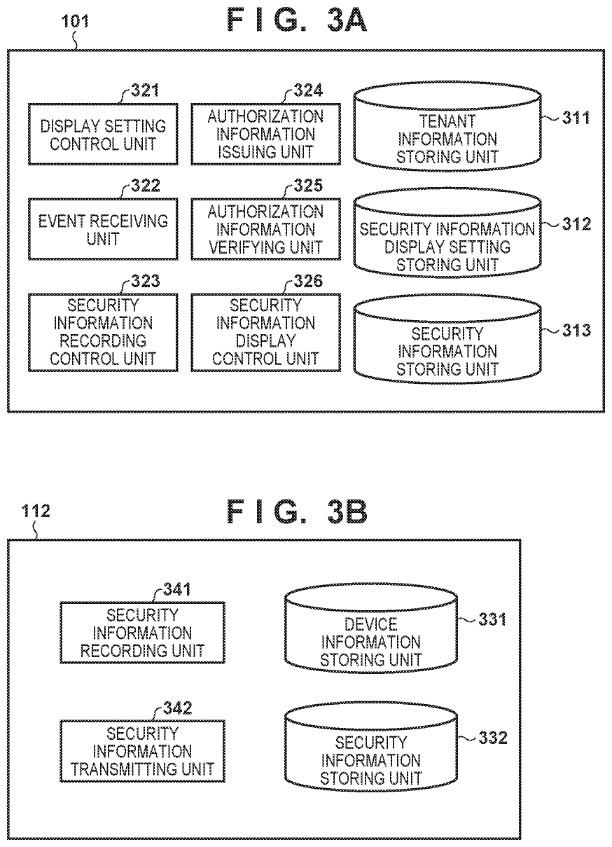

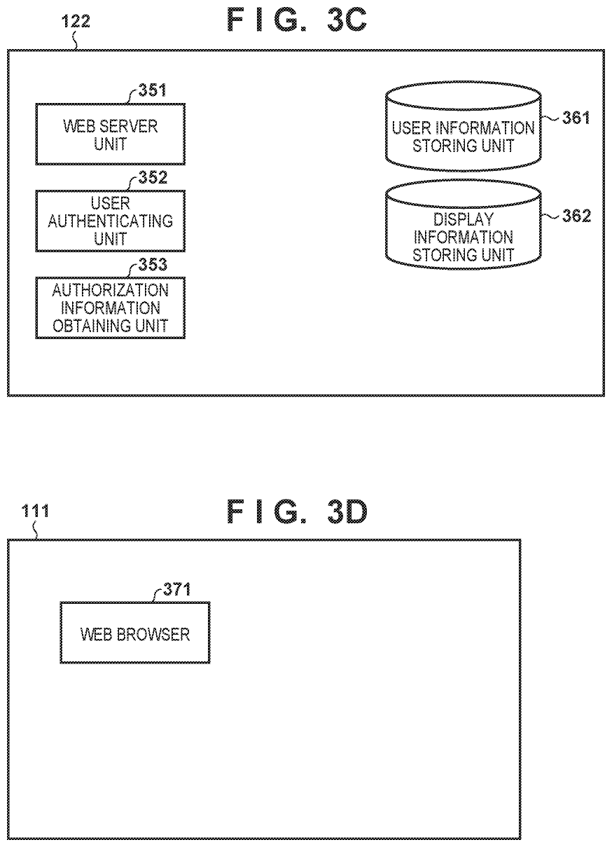

FIGS. 3A to 3D are diagrams illustrating the software configuration of the remote management system using the present invention. FIG. 3A is a diagram illustrating the software configuration of the cloud server 101. FIG. 3B is a diagram illustrating the software configuration of the image forming apparatus 112. FIG. 3C is a diagram illustrating the software configuration of the customer information management server 122. FIG. 3D is a diagram illustrating the software configuration of the information processing apparatus 111.

### Cloud Server 101 Software Configuration

The components of the software configuration of the cloud server 101 in FIG. 3A are implemented in the cloud server 101 by the CPU 223 loading a program stored in the hard disk 224 on the volatile memory 225 and executing the program.

A tenant information storing unit 311 stores a tenant information table in the hard disk 224 of the cloud server 101. An example of the tenant information table stored in the tenant information storing unit 311 is illustrated in Table 1.

TABLE 1
Tenant Information Table

| Tenant Identifier | Client Identifier |
|---|---|
| distributorA | Client_123 |
| customerA | Client_123 |
| customerAA | Client_123 |
| distributorB | Client_abc |
| customerB | Client_abc |

In the tenant information table in Table 1, the tenant identifier column is a column storing a tenant identifier for uniquely identifying tenant information. The client identifier column is a column storing a client identifier for uniquely identifying the customer information management server 122. In the example of Table 1, the customer information management server 122 with the client identifier “client_123” can access the tenants with the tenant identifiers “distributorA”, “customerA”, and “customerAA”. Also, the customer information management server 122 with the client identifier “client_abc” can access the tenants with the tenant identifiers “distributorB” and “customerB”. Tenant is a management unit for managing devices such as an image forming apparatus and an information processing apparatus and the users of the devices. One tenant may include one or more information processing apparatuses 111 and one or more image forming apparatuses 112. Also, one or more users may belong to each tenant.

Each record in the tenant information table is called a tenant information record and is registered when the customer information management server 122 starts a connection with the cloud server 101. Also, each record is updated when tenant information in the cloud server 101 is added, updated, or deleted.

A security information display setting storing unit 312 stores a security information display setting table in the hard disk 224 of the cloud server 101. An example of the security information display setting table stored in the security information display setting storing unit 312 is illustrated in Table 2.

TABLE 2
Security Information Display Setting Table

| | |
|---|---|
| Setting Value ID | 1234567 |
| Tenant Identifier | customerA |
| Default Settings Diagnosis | ON |
| Tampering Detection | OFF |
| Authentication Lockout Detection | OFF |
| Out-of-hours Login Detection | OFF |
| Restricted Time Start Time | 22:00 |
| Restricted Time End Time | 06:00 |

One group (in other words, one record) of security information display settings is listed in the security information display setting table of Table 2. In Table 2, the setting value ID column is a column storing a setting value ID, which is an identifier for uniquely identifying one group of security information display settings. The tenant identifier column is a column storing a tenant identifier with a valid display setting. The default settings diagnosis column is a column storing whether or not to display the diagnostic result of the settings status relating to the security settings of the image forming apparatus 112. Default settings diagnosis refers to diagnosing the level of security by determining whether or not the setting values of the image forming apparatus are the same as the default values when shipped. The tampering detection column is a column storing whether or not to display tampering detection of the image forming apparatus 112. The target of the tampering detection includes programs stored in a rewritable medium and may further include fixed value data.

The authentication lockout detection column is a column storing whether or not to display authentication lockout detection of the image forming apparatus 112. Authentication lockout refers to, for example, when login fails after exceeding the predetermined repeatable number of times and any further login operations are denied. The out-of-hours login detection column is a column storing whether or not to display out-of-hours login detection of the image forming apparatus 112. Out-of-hours login refers to a login operation in a specified time period or in a time period outside of a specified time period. The restricted time start time and restricted time end time columns are columns storing the restricted time start time and end time when displaying out-of-hours login detection.

The default settings diagnosis column to the out-of-hours login detection column indicate categories of events received from the image forming apparatus 112. These are targets of settings for displaying (in other words, providing display information) only events relating to security. Each record in the security information display setting table is called a security information display setting record and is registered in the table per tenant information. The security information display setting record is added at the time when tenant information relating to a customer is added to the cloud server 101 and updated when an update request is received from the customer information management server 122. The security information display setting table may also be referred to as information relating to the access privileges of users of each tenant for each category of security information or the range thereof. Alternatively, the table may be referred to as information indicating whether to allow display or not allow display.

A security information storing unit 313 stores a security information table storing the security information received from the image forming apparatus 112 in the hard disk 224 of the cloud server 101. An example of the security information table stored in the security information storing unit 313 is illustrated in Table 3.

TABLE 3
Security Information Table

| | |
|---|---|
| Security Alert ID | 1234567 |
| Tenant Identifier | customerA |
| Device ID | deviceA |
| Category | Default Settings Diagnosis |
| Alert Level | Confirmation Needed |
| Deletion State | FALSE |
| Date and Time of Occurrence | 2022/3/14 8:30 |
| Notes | |

One group (in other words, one record) of security information is listed in the security information table of Table 3. In Table 3, the security alert ID column is a column storing a security alert ID, which is an identifier for uniquely identifying security information. The tenant identifier column is a column storing a tenant identifier for uniquely identifying the customer managing the image forming apparatus 112. The device ID column is a column storing the device ID (also referred to as a device identifier) for uniquely identifying the image forming apparatus 112. The category column is a column storing the security information category. In the present embodiment, “default settings diagnosis”, “tampering detection”, “authentication lockout detection”, or “out-of-hours login detection” corresponding to the setting value managed in the security information display setting table (Table 2) is stored. “Tampering detection” may also be referred to as “software integrity verification”. “Out-of-hours login detection” may also be referred to as “login detection during monitored time period.”

The alert level column is a column storing the alert level of the security information. In the present embodiment, when the value of the category column is “tampering detection”, “action needed” is stored, and for other values, “confirmation needed” is stored. However, no such limitation is intended.

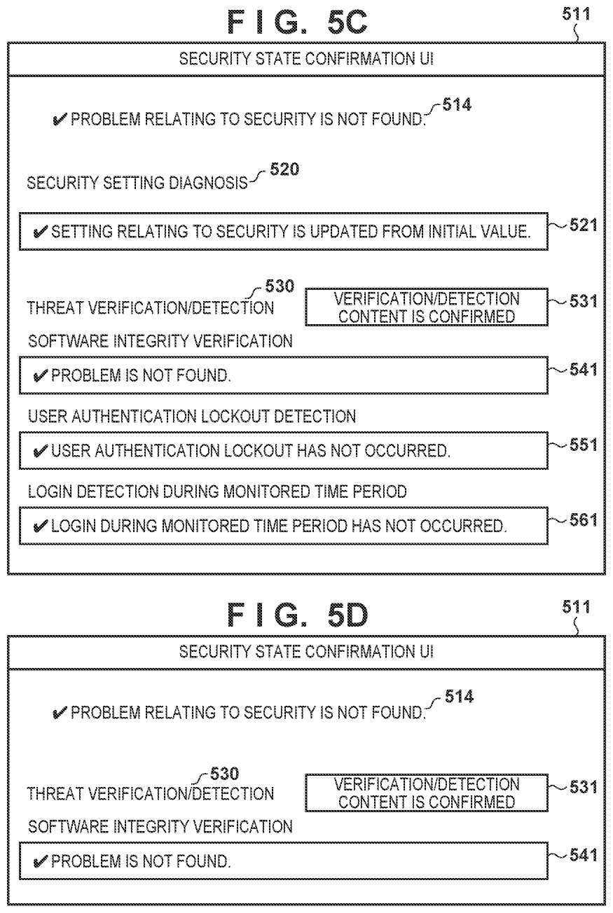

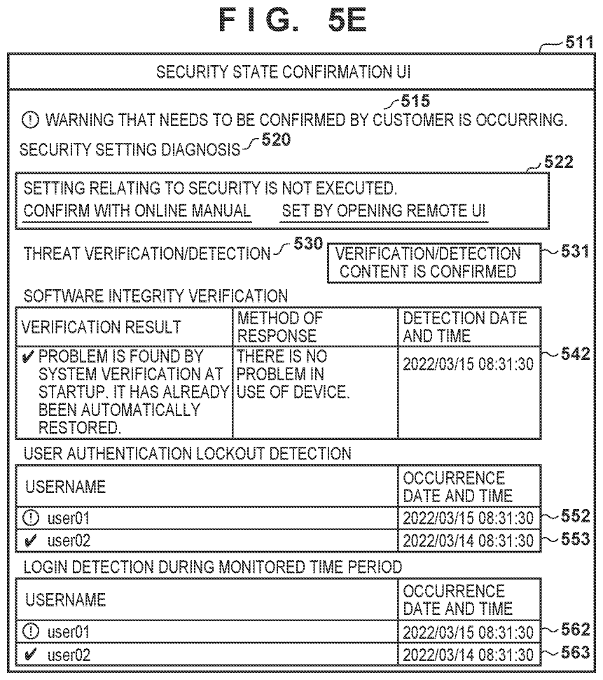

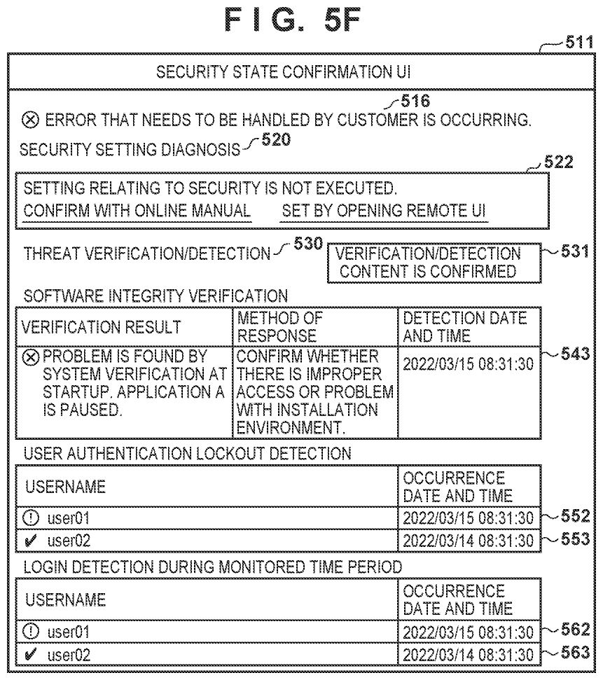

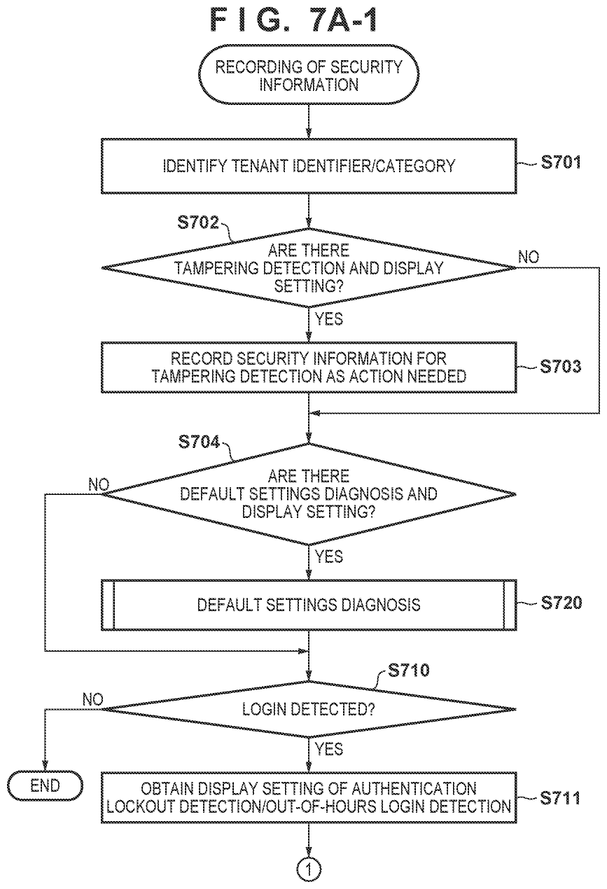

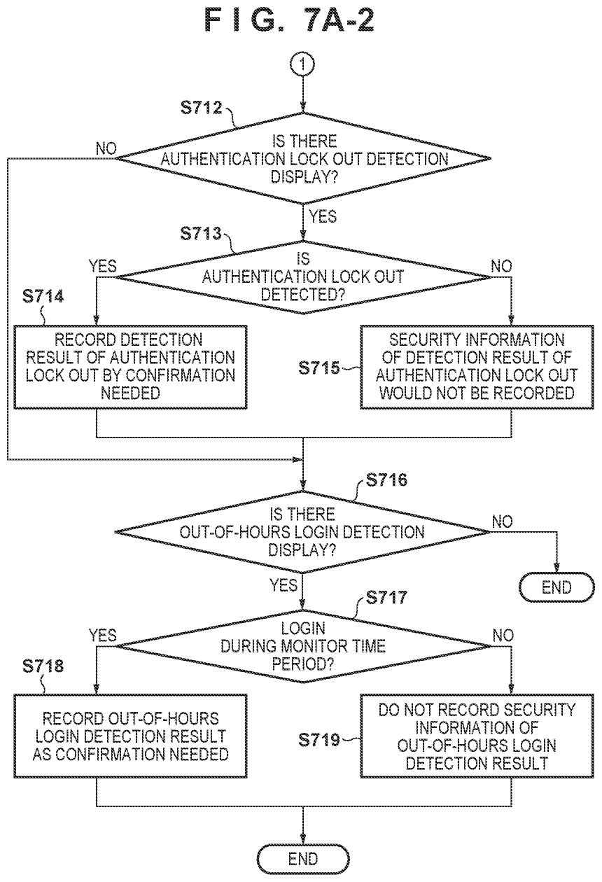

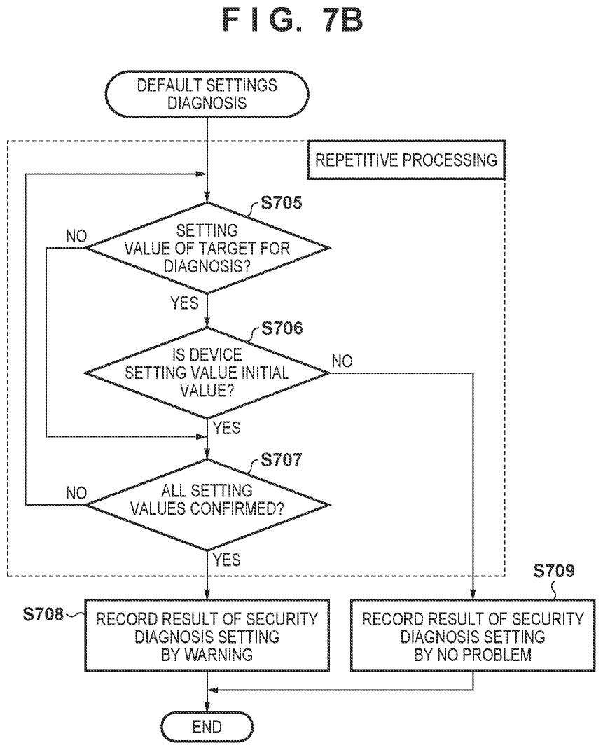

The deletion state column is a column storing whether or not the security information is in a deletion state. In the present embodiment, the security information being in a deletion state means that, in the case of security information relating to “default settings diagnosis”, the set state relating to the security of the image forming apparatus 112 is a state with no problems. Also, in the case of security information relating to “tampering detection”, “authentication lockout detection”, and “out-of-hours login detection”, it means that the customer administrator has confirmed the security information at a security state confirmation UI 511 described below. The value of the deletion state column is updated to the deletion state when the processing of step S709 in FIG. 7 described below is executed relating to the security information in which the value of the category column being “default settings diagnosis”. Relating to the security information in which the value of the category column is a value other than “default settings diagnosis”, value of the deletion state column is updated to the deletion state when a “confirm verification/detection content button” 531 in FIGS. 5C to 5F described below is pressed.

The date and time of occurrence column stores the date and time of when the image forming apparatus 112 communicated the security information. The notes column is a column storing an application name or login username when the security information communicated by the image forming apparatus 112 is “tampering detection”, “authentication lockout detection”, or “out-of-hours login detection”.

Each record in the security information table is called a security information record and is registered per image forming apparatus 112 in a case where the category is “default settings diagnosis” and is registered per security information communicated by the image forming apparatus 112 in other cases. A security information record is added by the processing of a security information recording control unit 323 described below.

A display setting control unit 321 is a function executed when a security information display setting request is received from the customer information management server 122. The display setting control unit 321 changes the display setting according to the security information display setting request. The received request information includes authorization information, a tenant identifier for uniquely identifying the customer targeted for settings, and post-change display setting information. The display setting control unit 321 sends a verification request for authorization information to an authorization information verifying unit 325 described below and updates the security information display setting only if the authorization information verification processing is successful. Furthermore, when the display setting of the item to be updated is updated from “ON” to “OFF”, records with a category value that matches the item to be updated are all deleted from the security information table (Table 3).

An event receiving unit 322 is a function executed when an event of the image forming apparatus 112 is received via the Network OF 226 provided in the cloud server 101. The received event includes at least a device ID for uniquely identifying the image forming apparatus 112 which is the transmission source of the event, a tenant identifier for uniquely identifying the customer managing the image forming apparatus 112, and event information. The event receiving unit 322 sends a request for a security information record to the security information recording control unit 323 described below only if the received event information is security information. In the present embodiment, the determination of whether the received event information is an event relating to security information is executed by referencing the information for identifying the type of event such as the event name included in the event information. However, no such limitation is intended.

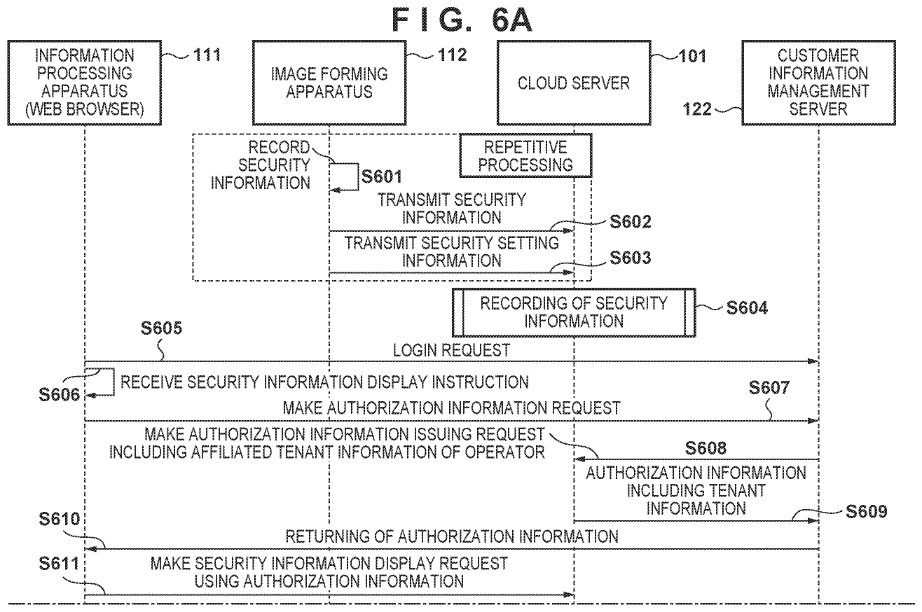

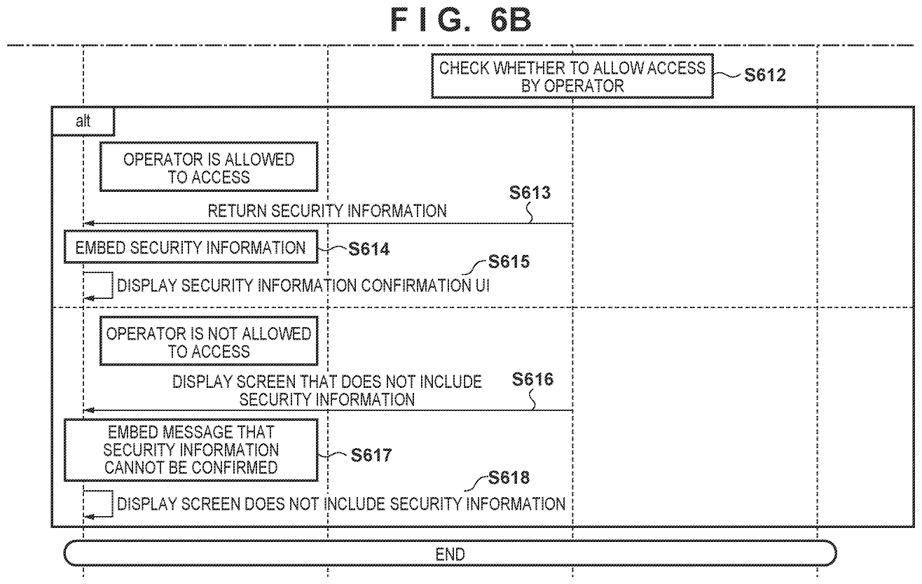

The security information recording control unit 323 is a function executed when a security information recording request is received from the event receiving unit 322. The security information recording control unit 323 records the target security information if the conditions are satisfied according to the security information recording request. The security information recording control unit 323 obtains the security information display setting record that matches the tenant identifier received from the event receiving unit 322 from the security information display setting table (Table 2). Also, the category information is identified from the security information received from the event receiving unit 322. The method of identifying category information according to the present embodiment includes identifying from the event name. However, no such limitation is intended. The security information recording control unit 323 references the obtained security information display setting record and the setting value of the identified category information and, when the setting value corresponding to the category is “OFF”, recording of the security information is not performed. When setting value is “ON”, recording of the security information according to the flowchart in FIGS. 6A and 6B described below is performed. In this manner, according to the present embodiment, whether or not to gather security information is controlled on the basis of the security information display setting. However, regardless of the setting values of the security information display setting, security information may be gathered, and the gathered security information may be provided to the user according to the security information display setting. The setting of each category of the security information display setting record may be referred to as a setting indicating whether or not to gather security information or a setting indicating whether or not to provide (display) the security information.

An authorization information issuing unit 324 is a function executed when an authorization information issuing request for obtaining security information is received from the customer information management server 122. In response to the authorization information issuing request, the authorization information issuing unit 324 issues the authorization information if the necessary conditions are met. When the security information is a resource, authorization information is an access token that is verified when accessing the resource. In order to manage the tenant information table (Table 1), the customer information management server 122 can access the plurality of customer tenant information it manages. However, the security information display request of the image forming apparatus 112 is performed by a customer administrator belonging to a customer tenant.

When the customer information management server 122 receives a display request from the web browser of the information processing apparatus 111, a website is provided that displays customer information managed by the customer information management server 122, information of the image forming apparatus, and the like. When a user such as the customer administrator successfully logs into the website, the information is provided. Also, when the user performs a security information display instruction operation on the website, to restrict the range of security information displayed on the web browser, the customer information management server 122 specifies the tenant identifier the user belongs to and performs an authorization information issuing request. The user is a logged-in user that has logged into the customer information management server 122 via the information processing apparatus 111 and performed a display request operation and that usually belongs to the same tenant as the information processing apparatus 111.

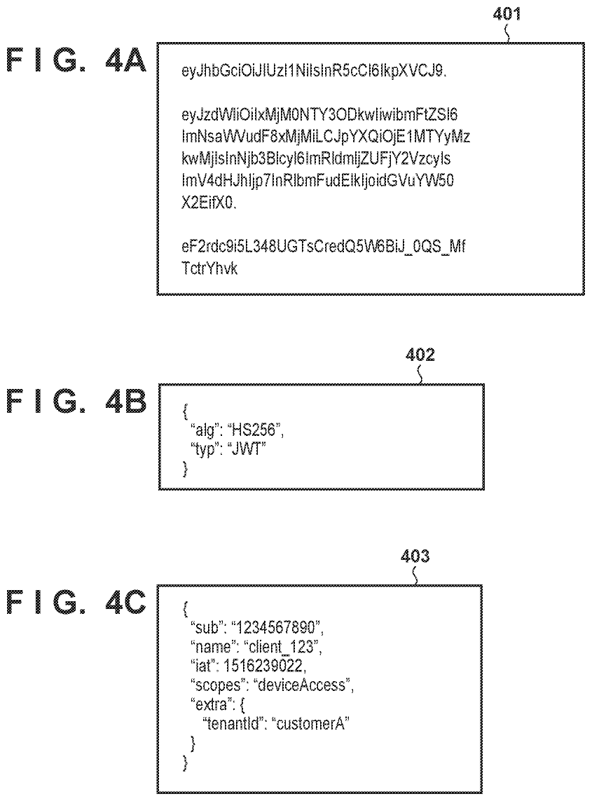

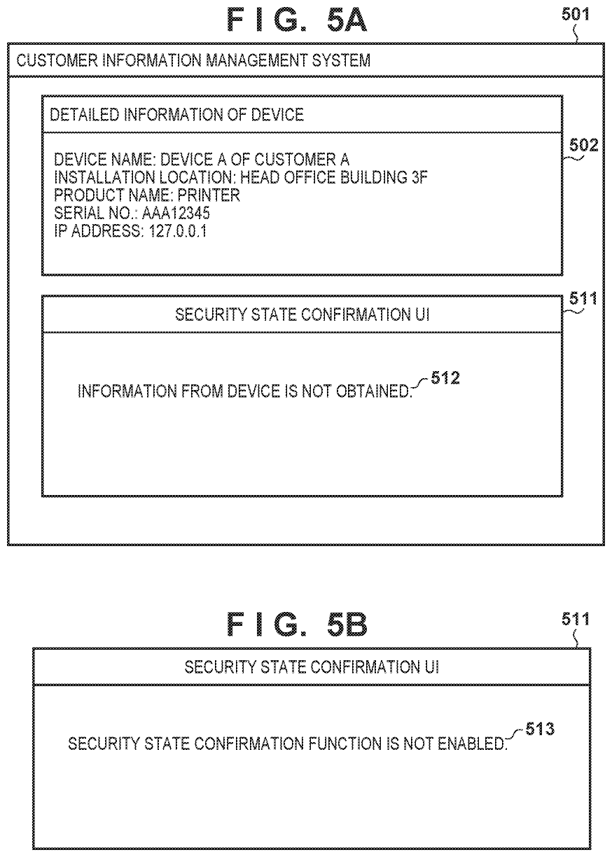

The authorization information issuing unit 324 stores a private key used to sign the authorization information to be issued and a public key for verifying the issued authorization information. FIGS. 4A to 4C are diagrams illustrating examples of authorization information issued by the authorization information issuing unit 324. Authorization information 401 represents the entire character string of the issued authorization information. The authorization information is divided in a header portion, a payload portion, and a signature portion, with a “.” connecting them. To facilitate viewing of the diagram, a line break has been inserted between each portion.

A header portion 402 is JSON data including the information relating to the algorithm used in the signature and the format of the authorization information. With the header portion 402, that the authorization information is signed using algorithm HS256 can be known from the alg claim. With a payload portion 403, for example, the issue date and time of the authorization information can be known from the sub claim, the client identifier can be known from the name claim, and the expiration date of the authorization information can be known from the iat claim. Also, the scope claim (privilege information) specifies the range of the privilege. In FIGS. 4A to 4C, for example, the specified privilege is a device resource and, in the present example, is an access privilege for the security information. The extra claim is an extension claim for storing the tenant identifier information specified by the customer information management server 122. Though further details are omitted, the authorization information issuing unit 324 verifies whether or not the request source is correct when the authorization information issuing request is received and issues the authorization information only when the request source is correct.

The authorization information verifying unit 325 is a function executed when an authorization information verification request is received from the display setting control unit 321 or a security information display control unit 326. The authorization information verifying unit 325 verifies the target authorization information according to the authorization information verification request and responds with a verification result of either verification success or verification failure. The received request information includes the authorization information and the tenant identifier of the access target. In the case of a verification request from the display setting control unit 321, the client identifier included in the payload portion of the authorization information and the tenant information managed with the tenant information table (Table 1) are compared. As a result of the comparison, when a tenant identifier of a tenant that a client specified by a client identifier can access is specified, verification success is determined. For example, the client identifier corresponding to the tenant identifier received together with the request information is obtained from the tenant information table, and if the client identifier matches the client identifier included in the authorization information, verification success is determined.

In the case of a verification request from the security information display control unit 326, the client identifier and the tenant identifier in the extension claim are obtained from the payload portion of the authorization information. Using the example illustrated in FIG. 4C of the received authorization information, the client identifier is “client_123” and the tenant identifier is “customerA”. Subsequently, a record that matches the combination of the client identifier and the tenant identifier is searched for in the tenant information table (Table 1). When a corresponding record is found, verification is successful. When no corresponding record is found, verification is a failure.

With the control described above, in the case of the security information display, control to allow access only to security information of a customer tenant information that a customer administrator who accesses the customer information management server 122 belongs to can be implemented.

The security information display control unit 326 implements the display of the security information via a web browser. Specifically, the security information is provided by embedding a script relating to a confirmation UI for controlling the display of the security information in the display information (HTML) of the website. On the web browser, the script is executed when the user performs a security information display instruction operation. In response to this operation, the confirmation UI portion (not illustrated) operating on the web browser transmits the resource (security information) request including the authorization information obtained from the customer information management server 122 to the security information display control unit 326. When the security information display control unit 326 receives the security information display request and verification of the authorization information is successful, the security information within the privilege range is returned to the confirmation UI portion. This is described below in detail with the processing of the flowchart in FIGS. 6A and 6B.

Of the configuration described above, from the display setting control unit 321 to the security information display control unit 326 may be collectively referred to as state monitor.

### Image Forming Apparatus 112 Software Configuration

The components of the software configuration of the image forming apparatus 112 in FIG. 3B are implemented in the image forming apparatus 112 by the CPU 207 loading a program stored in the hard disk 208 on the volatile memory 210 and executing the program.

A device information storing unit 331 is a function for storing a device information table in the hard disk 208 of the image forming apparatus 112. In the device information table, at least a device ID for uniquely identifying the image forming apparatus 112 and a tenant identifier for uniquely identifying a customer managing the image forming apparatus 112 are associated together and stored.

A security information storing unit 332 is a function for storing a security information table in the hard disk 208 of the image forming apparatus 112. In the security information table, the security information generated by a security information recording unit 341 described below is stored. Each record of the security information table is called a security information record and is added by the security information recording unit 341 described below recording security information. The security information is divided into one or more categories. In the present embodiment, at least one from the four including default settings diagnosis, tampering detection, user authentication lockout detection, and out-of-hours login detection may be included, for example, and in this example, all are included.

The security information recording unit 341 is a function that records the security information to the security information storing unit 332 when an event relating to security occurs in the image forming apparatus 112. In the present embodiment, cases such as tampering being detected or a login operation being performed are expected, but no such limitation is intended. When the security information is recorded, a record of the date and time of occurrence and additional information is also made.

A security information transmitting unit 342 is a function that transmits the security information together with its own device ID and the tenant identifier from the Network OF 205 provided in the image forming apparatus 112 to the cloud server 101. In the present embodiment, all of the security information being set to be transmitted from the image forming apparatus 112 to the cloud server 101 is assumed, but control may be performed with the settings of the security information display setting storing unit 312 and the transmission settings of the image forming apparatus 112 being coordinated. Also, the transmission settings may be able to be set for each category.

The security information transmitted by the security information transmitting unit 342 includes two types, a security information record recorded in the security information storing unit 332 and settings information relating to the security of the image forming apparatus 112. The settings information includes the transmission setting described above. The security information record is transmitted each time a security information record is added by the security information recording unit 341. The settings information relating to security is transmitted when the image forming apparatus 112 starts up, when a certain amount of time has passed from startup, and when there is an update to the settings information relating to security.

For example, when the setting (display setting) of the security information display setting storing unit 312 and the transmission setting of the image forming apparatus 112 do not conform, the cloud server 101 may issue an instruction to the image forming apparatus 112 to change the transmission setting so that it conforms with the display setting. For example, when the display setting is “display” but the transmission setting is “no transmission”, an instruction may be issued from the cloud server 101 to the image forming apparatus 112 to change the corresponding setting to “transmission”.

### Customer Information Management Server 122 Software Configuration

FIG. 3C is a diagram illustrating an example of the software configuration of the customer information management server 122. The components of the software configuration of the customer information management server 122 are implemented by the CPU 223 loading a program stored in the hard disk 224 on the volatile memory 225 and executing the program. A user information storing unit 361 stores user identification information, authentication information, and the like. The user identification information may include, for example, a user ID, a tenant identifier of a tenant a user belongs to, and the like. The authentication information may include the information necessary for authentication such as the password for each user. Also, when each user is provided with authorization information, the authorization information may be stored in association with the user. This association may be performed per user or may be performed per user-belonging tenant.

A display information storing unit 362 stores display information (also referred to as screen information) for a website provided to a web browser or the like operating on the information processing apparatus 111. The display information, for example, specifies the locations of pages using URL, URI, or similar location specifying information per page described using a predetermined description language, such as HTML, XML, or the like. The display information includes display information for displaying the state of the device to be managed of the image forming apparatus 112 or the like, for example. The display information may include fixed text, graphics, and similar contents in a layout or may include regions with dynamic contents inserted in a layout. Also, the display information may include a script executed by the web browser, and dynamic contents may be able to be displayed by executing the script. Also, the security information display information obtained from the cloud server 101 may be temporary stored in the display information storing unit 362.

A web server unit 351 obtains the specified display information from the display information storing unit 362 in response to a request received from the web browser (also simply referred to as a browser) and provides the display information to the browser.

A user authenticating unit 352 performs user authentication in response to a login operation at a page for login provided to the web browser of the information processing apparatus 111. The user authentication may be performed by comparing the input user identification information and authentication information with the user identification information and authentication information stored in the user information storing unit 361. If the comparison is a success, user authentication is successful, and the top of the display information is transmitted to the browser and displayed. The display information may include an operation menu, and the menu may include a security information display request, a change to settings relating to security, and the like, for example. A user who is successful authenticated is referred to as a login user. If comparison fails, the information processing apparatus 111 is notified of this.

An authorization information obtaining unit 353 requests the cloud server 101 for the authorization information and obtains the authorization information from the cloud server 101. The obtained authorization information is provided to the web browser when displaying the security information and is stored in the user information storing unit 361.

Note that the user authentication may be performed by a different authentication server, and, in this case, the authentication server includes the user information storing unit 361 and a user authenticating unit 352.

### Information Processing Apparatus 111 Software Configuration

FIG. 3D is a diagram illustrating an example of the software configuration of the information processing apparatus 111. The information processing apparatus 111 includes a web browser 371. The web browser 371 may be generic software that executes a description language and scripts, displays a screen, and receives information input by a user. Naturally, basic software such as an operating system and the like are also provided, but description thereof is omitted. This is the same for the software of other devices.

### Display Screen Example

FIGS. 5A to 5F are diagrams illustrating examples of customer information management screens provided by the customer information management server 122. The customer information management server 122 is a server that provides contract information and consumables information at a portal site (website functioning as an entrance) for a specific customer. By using the present invention, the customer information management server 122 can further provide information with the security information confirmation UI embedded by the security information display control unit 326. A customer portal screen 501 is a portal site for a specific customer provided by the customer information management server 122. When a user specifies the location of this portal site at the web browser 371 and logs in, the customer portal screen 501 is transmitted from the customer information management server 122 to the web browser 371 and displayed.

The customer portal screen 501 in FIG. 5A includes customer information 502 that displays contract information, consumables information, and the like managed by the customer information management server 122 and a security state confirmation UI 511 relating to the image forming apparatus 112 managed by the cloud server 101. The customer information 502 illustrated is an example in which information relating to the image forming apparatus 112 managed by the customer information management server 122 is displayed, but no such limitation is intended. The security state confirmation UI 511 is a UI displayed for the customer administrator to confirm (or reference) the security information relating to the image forming apparatus 112.

The security state confirmation UI 511 is a region that displays the security information obtained by a confirmation UI unit operating on the web browser executing a security information display request including the authorization information with respect to the cloud server 101. The authorization information is obtained by the web browser via the customer information management server 122, in response to the execution of a script embedded in the display information of the website and relating to the confirmation UI, and issued by the cloud server 101. The security information confirmation UI is a UI element implemented by a predetermined description language (Javascript (registered trademark) or the like) that can dynamically display the latest security information.

A message field 512 is an example of a message displayed when the security information has not been received from the image forming apparatus 112 even though the item managed by the security information display setting storing unit 312 is set to the “ON” item for the display setting. A message field 513 illustrated in FIG. 5B is an example of a message displayed when the display setting items managed by the security information display setting storing unit 312 are all set to “OFF”.

A message field 514 in FIG. 5C is an example of a message displayed when the display setting for “default settings diagnosis” managed by the security information display setting storing unit 312 is set to “ON” and there is no security problem in the “default settings diagnosis”. Specifically, in this case, the record for the category “default settings diagnosis” included in the security information table (Table 3) is in a deletion state.

Message fields 520 and 521 are examples of messages displayed when the display setting for “default settings diagnosis” managed by the security information display setting storing unit 312 is set to “ON”. The display conditions for the message field 521 is similar to that for the message field 514.

A message field 530 and an operation button 531 are examples of messages displayed when the display setting for either “tampering detection”, “authentication lockout detection”, or “out-of-hours login detection” from among the items managed by the security information display setting storing unit 312 is set to “ON”. The operation button 531 is displayed in an enabled state when unconfirmed security information exists and is displayed in a disabled state when the security information has all been confirmed. Specifically, when no record exists relating to “tampering detection”, “authentication lockout detection”, and “out-of-hours login detection” for the value of the category in the security information table (Table 3) or all records are in the deletion state, the operation button 531 is displayed in a disabled state. However, when one is present that is not in the deletion state, the operation button 531 is displayed in an enabled state. When the operation button 531 in an enabled state is pressed, the security information records not in a deletion state are updated to the deletion state, and the operation button 531 is put in a disabled state.

A message field 541 is an example of a message displayed when the display setting for “tampering detection” managed by the security information display setting storing unit 312 is set to “ON” and no record exists with “tampering detection” for the value of the category in the security information table (Table 3). In a similar manner, a message field 551 is an example of a message displayed when the target category is “authentication lockout detection” and the display setting is set to “ON” but no target security information record exists. A message field 561 is an example of a message displayed when the target category is “out-of-hours login detection” and the display setting is set to “ON” but no target security information record exists.

FIG. 5D is a diagram illustrating an example when only the display setting for “tampering detection” is set to “ON” and the display setting for other items is set to “OFF” and no security information record exists.

FIGS. 5E and 5F are diagrams illustrating examples of the security state confirmation UI 511 in a state in which a security problem has occurred. Message fields 515 and 516 display a message corresponding to the alert level. The message field 515 is an example of a message displayed when the alert level is “confirmation needed”. The message field 516 is an example of a message displayed when the alert level is “action needed”. Specifically, the message field 515 is displayed when the alert level for all of the security information records not in the deletion state in the security information table (Table 3) is “confirmation needed”. The message field 516 is displayed when a record with an alert level of “action needed” exists among the security information records not in the deletion state in the security information table (Table 3). A message field 522 is an example of a message displayed when a problem has occurred in the settings information relating to the security of the image forming apparatus 112. Specifically, in this case, the record with “default settings diagnosis” for the value of the category in the security information table (Table 3) exists not in the deletion state.

Tampering detection records 542 and 543 display the entire record with “tampering detection” for the value of the category in the security information table (Table 3). The tampering detection record 542 (FIG. 5E) illustrates an example of when the record to be displayed is in the deletion state (has been confirmed by the customer administrator). The tampering detection record 543 (FIG. 5F) illustrates an example of when the record to be displayed is not in the deletion state (has not been confirmed by the customer administrator). In the illustrated example, when the security information has been confirmed, an icon indicating this is displayed, and when the security information has not been confirmed, an error icon is displayed to make the security information easily understood. When there are many target records, control may be performed to sort the records by date and time of occurrence or the number to display may be restricted.

Authentication lockout detection records 552 and 553 display the entire record with “authentication lockout detection” for the value of the category in the security information table (Table 3). The authentication lockout detection record 552 illustrates an example of when the record to be displayed is not in the deletion state (has not been confirmed by the customer administrator). The authentication lockout detection record 553 illustrates an example of when the record to be displayed is in the deletion state (has been confirmed by the customer administrator). The display control is similar to that for the tampering detection records 542 and 543.

Out-of-hours login detection records 562 and 563 display the entire record with “out-of-hours login detection” for the value of the category in the security information table (Table 3). The out-of-hours login detection record 562 illustrates an example of when the record to be displayed is not in the deletion state (has not been confirmed by the customer administrator). The out-of-hours login detection record 563 illustrates an example of when the record to be displayed is in the deletion state (has been confirmed by the customer administrator). The display control is similar to that for the tampering detection records 542 and 543.

By using the security state confirmation UI 511 described above, the security state of the image forming apparatus 112 managed by the customer administrator can be confirmed in real time. Also, since the security information is provided in an integrated manner by the cloud server 101 that manages the image forming apparatus, the customer information management server 122 does not need to generate the security state confirmation UI 511. Also, the format and contents of the provided security information are unified, and, via the plurality of customer information management servers 122, variation in the accuracy of the display format and information is removed.

### Security Information Display Sequence

A first embodiment will be described below using the flowchart of FIGS. 6A and 6B. FIGS. 6A and 6B show a flowchart of processing executed when an event relating to security occurs in the image forming apparatus 112.

In step S601, an event relating to security occurs in the image forming apparatus 112. The event, for example, includes information relating to adding or setting a verification or detection result belonging to one of the categories of the security information.

In step S602, the security information transmitting unit 342 transmits, to the cloud server 101, event information of the event that occurred in step S601 and its own device ID and tenant identifier stored by the device information storing unit 331.

In step S603, when the image forming apparatus 112 detects a change in the settings relating to its own security, information relating to the security settings and its own device ID and tenant identifier stored by the device information storing unit 331 are transmitted to the cloud server 101.

In step S604, the security information recording control unit 323 records the security information received by the event receiving unit 322 in step S602 or S603. This is described below in detail in the flowchart of FIGS. 7A and 7B. Note that the processing from steps S601 to S603 is repeated each time an event occurs or the settings are changed at the image forming apparatus 112. Also, though a detailed description is omitted, the settings information relating to the security of the image forming apparatus 112 are transmitted from the security information transmitting unit 342 when the image forming apparatus 112 starts up or at a determined time period.

In step S605, the web browser executed by the information processing apparatus 111 accesses the portal site provided by the customer information management server 122 according to a customer user operation and transmits a login request. After receiving the login request, the customer information management server 122 executes authentication processing on the login information received together with the login request. The customer user, for example, can log in using the customer ID or the user ID and the authentication information as the login information. Also, at the customer information management server 122, the tenant information to which the customer administrator belongs is managed. When login is successful, an initial screen of the portal site is transmitted from the customer information management server 122 to the browser 371 and displayed. On the initial screen, a button, a menu, and the like for displaying the security information are displayed.

In step S606, according to a user operation at the web browser 371, a security information display instruction is received.

In step S606, in response to the customer user operation, the web browser 371 transmits an authorization information request to the customer information management server 122. The request at least includes device ID information (device identifier) for identifying the display target image forming apparatus 112.

In step S608, after receiving the security information display request from the customer administrator, the customer information management server 122 identifies the tenant identifier that the customer administrator belongs to and performs an authorization information issuing request for security information display to the authorization information issuing unit 324.

In step S609, the authorization information issuing unit 324 issues the authorization information including the tenant identifier received with the authorization information issuing request and transmits the authorization information to the customer information management server 122.

In step S610, after the authorization information is received from the authorization information issuing unit 324, the customer information management server 122 returns (or transmits back) the authorization information to the browser 371. In step S611, the web browser 371 passes the authorization information to the confirmation UI unit operating on the web browser, and a security information display request is transmitted from the confirmation UI unit to the security information display control unit 326. The display request corresponds to a resource request including authorization information.

In step S612, the security information display control unit 326 sends a request to the authorization information verifying unit 325 to verify the authorization information included in the display request. When verification of the authorization information is successful, whether the customer information management server 122 can be accessed with the customer information identified by the tenant identifier included in the authorization information is verified. Also, whether the image forming apparatus 112 identified by the received device ID is under the customer management of the tenant identifier included in the authorization information is verified. Here, whether the image forming apparatus identified by the device ID belongs to the tenant identified by the tenant identifier may be verified. When all of the verifications are successful, it is determined that the customer administrator has security information display privilege, and the processing of steps S613 to S615 is executed. When there is a problem in the verification result (verification fails), the processing of steps S616 to S618 is executed. Via the processing of step S610, for example, even when the device ID of the image forming apparatus 112 not under the management of a customer the customer administrator belongs to is specified and a fraudulent attempt to display the security information is made, display of the security information can be prevented.

In step S613, the security information display control unit 326 returns the security information to the confirmation UI unit.

In step S614, the confirmation UI unit embeds the security information in the security state confirmation UI 511. The security information confirmation UI may be information with the security information embedded in a template prepared in advance according to the display setting of the security information, for example. In step S615, the security state confirmation UI 511 is displayed on the browser, and the processing ends. The security information can be referenced and confirmed via the display screens as illustrated in FIGS. 5A to 5F by the customer user.

On the other hand, when display of the security information is not allowed, in step S616, the security information display control unit 326 notifies the confirmation UI unit that access is not allowed (that is, display is not allowed).

In step S617, the confirmation UI unit embeds the message 513 that security information is not allowed to be displayed in the security state confirmation UI 511.

In step S618, the web browser 371 displays a screen without the security information, and the processing ends.

According to the flowchart in FIGS. 6A and 6B described above, the security information received from the image forming apparatus 112 can be displayed only to the customer administrator with the correct privileges.

Note that in the process in FIGS. 6A and 6B, the authorization information is issued by the cloud server 101. However, the authorization information may be issued by an authorization system prepared separate to the cloud server 101. Also, each time there is an attempt to issue a security information display request, the authorization information does not need to be obtained, and authorization information obtained once and stored can be reused. In this case, when the authorization information becomes invalid due to the expiration of a time period or the like, the authorization information may be re-obtained.

### Security Information Recording Processing by Cloud Server 101

FIGS. 7A and 7B are flowcharts of the processing executed when the security information recording control unit 323 receives the security information from the image forming apparatus 112. At the security information recording control unit 323, recording determination is performed for each category of the received security information. Steps S702 to S703 corresponds to the recording determination processing for “tampering detection”, steps S704 to S709 correspond to the recording determination processing for “default settings diagnosis”, steps S712 to S715 correspond to the recording determination processing for “authentication lockout detection”, and steps S716 to S719 correspond to the recording determination processing for “out-of-hours login detection”. Depending on the category of the received security information, one type of processing is executed.

In step S701, the security information recording control unit 323 identifies the tenant identifier and the category of the security information from the received security information. The category of the security information is identified via determination using the event name, but no such limitation is intended.

In step S702, when the category identified in step S701 is “tampering detection”, the record of the tenant identifier identified in step S701 from the security information display setting table (Table 2) is obtained, and the display setting for “tampering detection” is confirmed. When the display setting is “ON”, the processing of step S703 is executed, and when the display setting is “OFF”, the processing of step S704 is executed.

In step S703, the security information recording control unit 323 adds the received security information to a record of the security information table (Table 3). The security alert ID of the added record is newly issued, the category is “tampering detection”, the alert level is “action needed”, and the deletion state is “FALSE” (no deleted). When the received security information includes an application name, information is also added to the notes column.

In step S704, when the category identified in step S701 is “default settings diagnosis”, the record of the tenant identifier identified in step S701 from the security information display setting table (Table 2) is obtained, and the display setting for “default settings diagnosis” is confirmed. When the display setting is “ON”, the processing of step S720 is executed, and when the display setting is “OFF”, the processing of step S710 is executed. Note that the security information relating to “default settings diagnosis” is combined with the setting name and setting value relating to the security of the image forming apparatus 112 and communicated. When the image forming apparatus 112 is started up or upon periodic transmission, all of the combinations are communicated, and when there is a change in the setting value, it is expected that only the changed combination is communicated.

The details of step S720 that branches from step S704 are illustrated in FIG. 7B, but in the description, this will be described as a part of the whole processing of FIGS. 7A-1 and 7A-2. In step S720, default settings diagnosis is performed. Step S720 includes from step S705 to step S709.

The processing from step S705 to step S707 is processing that is repeatedly executed for each combination of communicated setting values. Also, at the security information recording control unit 323, the name of the setting to be diagnosed and the initial value corresponding to the setting name is managed in advance (not illustrated). In the present embodiment, when all of the setting values defined in advance to be diagnosed are the initial values, it is determined that there is a security problem. When even one of the setting values is different from the initial value, it is determined that there is no security problem. However, the determination method is not limited to this method. For example, when a value different from the initial value is set for setting items numbering a predetermined number of two or more, it may be determined that there is no problem, or when a value different from the initial value is set for all of the setting items, it may be determined that there is no problem.

In step S705, the security information recording control unit 323 determines whether the setting name of the received security information is a target for default settings diagnosis. When it is a target for diagnosis, the processing of step S706 is executed. When it is not a target for diagnosis, the processing of step S707 is executed.

In step S706, the security information recording control unit 323 determines whether the setting value of the received setting name is the initial value. When the setting value is not the initial value, the processing of step S709 is executed, and when the setting value is the initial value, the processing of step S707 is executed.

In step S707, the security information recording control unit 323 determines whether the combinations of all of the setting values in the received security information have been checked. When all checks are complete, it is determined that all of the setting values are the initial value, and the processing of step S708 is executed. When there is an unchecked setting value, the next setting value is targeted and a similar determination is performed.

In step S708, the security information recording control unit 323 updates or adds a record of the security information table (Table 3). When a record exists in which the value of the device ID column is the same as the ID identifying the image forming apparatus 112 and the value of the category column is “default settings diagnosis”, only the value of the date and time of occurrence column is updated. When the value for the deletion state column is “TRUE”, it is updated to “FALSE”. When a corresponding record does not exist, a new security alert ID is issued, and a record is added with “default settings diagnosis” for the category, “confirmation needed” for the alert level, and “FALSE” for the deletion state.

In step S709, the security information recording control unit 323 updates or adds a record of the security information table (Table 3). When a record exists in which the value of the device ID column is the same as the ID identifying the image forming apparatus 112 and the value of the category column is “default settings diagnosis”, only the value of the date and time of occurrence column is updated. When the value for the deletion state column is “FALSE”, it is updated to “TRUE”. When a corresponding record does not exist, a new security alert ID is issued, and a record is added with “default settings diagnosis” for the category, “good” for the alert level, and “TRUE” for the deletion state.

Returning to FIGS. 7A-1 and 7A-2, in step S710, whether the category determined in step S701 is “login detection” is determined. In the present embodiment, as security information, two types of login detection, “authentication lockout detection” and “out-of-hours login detection”, are recorded and managed. Since the security information communicated from the image forming apparatus 112 is login detection information, the record of the security information is determined according to the content of the communicated login detection information and the settings status of the security information display setting table (Table 2). When the category identified in step S701 is “login detection”, the processing of step S711 is executed, and when not “login detection”, the processing ends.

In step S711, the security information recording control unit 323 obtains a record of the tenant identifier identified in step S701 from the security information display setting table (Table 2) and obtains the display setting for “authentication lockout detection” and “out-of-hours login detection”.

In step S712, the security information recording control unit 323 confirms the display setting for “authentication lockout detection”. When the display setting is “ON”, the processing of step S713 is executed, and when the display setting is “OFF”, the processing of step S716 is executed.

In step S713, the security information recording control unit 323 determines whether the login relates to a lockout detection from the login detection information, which is the received security information. When the login relates to a lockout, the processing of step S714 is executed, and when the login does not relate to a lockout, the processing of step S715 is executed.

In step S714, the security information recording control unit 323 adds a record of the security information table (Table 3). The security alert ID of the added record is newly issued, the category is “authentication lockout detection”, the alert level is “confirmation needed”, and the deletion state is “FALSE”. When the received security information includes a login username, information is also added to the notes column.

In step S715, the security information recording control unit 323 determines that an authentication lockout has not occurred and does not record security information relating to an authentication lockout detection.

In step S716, the security information recording control unit 323 confirms the display setting for “out-of-hours login detection”. When the display setting is “ON”, the processing of step S717 is executed, and when the display setting is “OFF”, the processing ends.

In step S717, the security information recording control unit 323 obtains a record of the tenant identifier identified in step S701 from the security information display setting table (Table 2) and obtains the setting value for the “restricted time start time” and the “restricted time end time”. The time of login success is identified from the login detection information, which is the received security information, and whether it is a login between the restricted time start time and the end time of the security information display setting record is determined. When the login is within the restricted time, the processing of step S718 is executed, and when the login is outside of the restricted time or login fails, the processing of step S719 is executed.

In step S718, the security information recording control unit 323 adds a record of the security information table (Table 3). The security alert ID of the added record is newly issued, the category is “out-of-hours login detection”, the alert level is “confirmation needed”, and the deletion state is “FALSE”. When the received security information includes a login username, information is also added to the notes column.

In step S719, the security information recording control unit 323 determines that a login within the restricted time has not occurred, does not record security information relating to out-of-hours login detection, and ends the processing.

According to the flowchart of FIG. 7 described above, the security information communicated from the image forming apparatus 112 can be recorded in a manner suitable for the security information display setting of the customer information. Thus, according to the present embodiment, the security information of the image forming apparatus is further gathered by the cloud server, and a customer information management server as a UI element can be provided. Also, the customer information management server can provide to a browser screen information embedded with the UI element for display. Thus, by the customer information management server providing the user with the security information without directly accessing the security information, the security can be improved and the display format can be unified.

Note that in the present embodiment, the display setting is provided per category, but one display setting may be set for the overall security settings. Alternatively, an overall display setting may be set in addition to a display setting per category, and whether or not the user can access the security information is determined by a logical conjunction of the settings.

### Modified Examples

In the embodiment described above, the customer information management server 122 transmits the screen information embedded with a script to the browser. Then, after executing the script, the browser obtains the security information confirmation UI from the cloud server 101 and displays the security information confirmation UI. In another configuration, the customer information management server 122, in a templated generated in advance, embeds the security information confirmation UI obtained from the cloud server 101 in the display information and transmits this to the information processing apparatus 111. In this case, the customer information management server 122 can obtain the security information confirmation UI when the confirmation information is presented to the cloud server 101 and authentication is successful. With this configuration, the template includes a fixed component of a portal site prepared in advance, and the security information confirmation UI is embedded in the fixed component. In this manner, in addition to the effect of the embodiment described above, the load on the information processing apparatus 111 can be reduced.

### Second Embodiment

In the method according to the first embodiment described above, the security information of the image forming apparatus 112 under control of the customer (that is, tenant) that the customer administrator (also referred to as a customer user) belongs to is displayed securely. In the present embodiment, a method for controlling the display of the security information according to the role of the customer administrator will be described.

An example of the security information display setting table stored in the security information display setting storing unit 312 according to the present embodiment is illustrated in Table 4.

TABLE 4
Security Information Display Setting Table

| | |
|---|---|
| Setting Value ID | 1234567 |
| Tenant Identifier | customerA |
| Default Settings Diagnosis | ON |
| Tampering Detection | OFF |
| Authentication | OFF |
| Lockout Detection | |
| Out-of-hours Login Detection | OFF |
| Restricted Time Start Time | 22:00 |
| Restricted Time End Time | 06:00 |
| Department Setting | IT Department: Default Settings |
| | Diagnosis/Tampering Detection |
| | Management Department: Authentication |
| | Lockout Detection/Out-of-hours Login |
| | Detection |

Table 4 is the security information display setting table of Table 2 with a department setting column added and a display setting stored for each department. In the example of Table 4, the IT department can display (allowed or permitted to display) the security information for “default settings diagnosis” and “tampering detection” and the management department can display the security information for “authentication lockout detection” and “out-of-hours login detection”. The display setting for each department can also be referred to as the range of access privilege for the security information of each department.

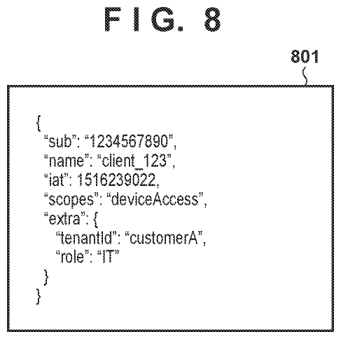

FIG. 8 is a diagram illustrating a payload portion 801 of authorization information issued by the authorization information issuing unit 324 using the present embodiment. The customer information management server 122 using the present embodiment, via the processing of step S608, adds the affiliated tenant information and the affiliated department information of the customer administrator and performs an authorization information issuing request. For example, the department the user belongs to may be stored in the user information storing unit 361 or the department the login user belongs to may be obtained when logging in and associated with the login user and stored. After receiving the authorization information issuing request, the authorization information issuing unit 324 adds the tenant identifier and the department information to an extra claim, which is an extension claim, and issues the authorization information.

In the verification processing of step S612 using the present embodiment, it is determined that display is allowed of, from among the security information of the image forming apparatus 112, only the security information which is allowed to be displayed to the department included in the extension claim. In other words, the security information which is allowed to be displayed is determined per category as in the first embodiment, for example. At this time, in addition to the ON/OFF setting of each category, the display setting for each department received via the extension claim of the authorization information is determined by referencing the security information display setting table. Then, the security information with the display setting set to ON and with a category in which the department display setting is set to allow or permit is transmitted to the information processing apparatus 111 (in particular, the web browser 371) in step S613. The subsequent processing is as in the first embodiment.

Via the control described above, in the present embodiment, in addition to obtaining the effect of the first embodiment, the display of the security information can be controlled according to the department the customer administrator belongs to.

Also, in addition to each department, the display of the security information can be controlled according to each user. In this case, at the user information storing unit 361, for example, information indicating whether or not display is allowed per category is associated with each user as with the department setting in Table 4, and whether or not to display the security information may be determined by referencing the associated information. Accordingly, the customer information management server 122, and not the cloud server 101, stores the display setting for each user, and thus the determination may be performed by the customer information management server 122.

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium′) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-088880, filed May 31, 2022 which is hereby incorporated by reference herein in its entirety.

What is claimed is:

1. A network system comprising:
an image processing apparatus;
an information processing apparatus including a web browser;
a service providing system that provides a website; and
a device management system that gathers and manages security information received from the image processing apparatus, wherein
the information processing apparatus, in response to receiving a display instruction for security information from a user logging into the service providing system via the web browser via a user operation, transmits a request for authorization information to the service providing system,
the information processing apparatus, in response to receiving authorization information issued by the device management system from the service providing system via the web browser, transmits a security information display request including the authorization information and a specification of a device identifier to the device management system,
the device management system, when allowing the user logged into the service providing system access to the security information on a basis of verification of the authorization information included in the security information display request, transmits security information display information associated with the device identifier to the information processing apparatus, and
the information processing apparatus receives the security information display information from the device management system and displays a screen including the security information display information via the web browser.

2. The network system according to claim 1, wherein
the device management system determines whether or not to allow the user logged into the service providing system to access the security information associated with the device identifier on a basis of a privilege included in the authorization information.

3. The network system according to claim 2, wherein
the device management system determines whether or not to allow the user to access the security information associated with the device identifier on a basis of a display setting of the security information in addition to the authorization information.

4. The network system according to claim 3, wherein
the device management system determines whether or not to allow the user to access the security information associated with the device identifier on a basis of a setting of a department the user who is logged in belongs to in addition to the authorization information and the display setting of the security information.

5. The network system according to claim 3, wherein
the image processing apparatus determines whether or not to transmit the security information to the device management system according to a transmission setting indicating whether or not to transmit the security information to the device management system, and
the device management system, when the transmission setting received from the device management system is set to not transmit and the display setting is set to allow access, instructs the image processing apparatus to set the transmission setting to transmit.

6. The network system according to claim 5, wherein
the transmission setting and the display setting are set for each category of the security information.

7. The network system according to claim 1, wherein
the device management system, when the security information display request is not allowed on a basis of the authorization information, transmits information indicating not allowed to the information processing apparatus, and
the information processing apparatus receives the information indicating not allowed from the device management system, and the security information is displayed via the web browser on a screen including information indicating that display is not allowed.

8. The network system according to claim 1, wherein
the security information includes at least one category from among default settings diagnosis, tampering detection, user authentication lockout detection, and monitored time period login detection, and
the device management system gathers the at least one category for each device identifier as the security information from the image processing apparatus.

9. The network system according to claim 1, wherein
the network system transmits a security information display request to the device management system and displays a screen including security information display information received from the device management system, by executing on the web browser and by a script embedded in display information provided from the service providing system.

10. An information providing method using a network system including an image processing apparatus, an information processing apparatus including a web browser, a service providing system that provides a website, and a device management system that gathers and manages security information received from the image processing apparatus, the information providing method comprising:
the information processing apparatus, in response to receiving a display instruction for security information from a user logging into the service providing system via the web browser via a user operation, transmitting a request for authorization information to the service providing system;
the information processing apparatus, in response to receiving authorization information issued by the device management system from the service providing system via the web browser, transmitting a security information display request including the authorization information and a specification of a device identifier to the device management system;
the device management system, when allowing the user logged into the service providing system access to the security information on a basis of verification of the authorization information included in the security information display request, transmitting security information display information associated with the device identifier to the information processing apparatus; and
the information processing apparatus receiving the security information display information from the device management system and displaying a screen including the security information display information via the web browser.
